(19) United States
(12) Patent Application Publication
(10) Pub. No.: US 2008/0232279 A1
(43) Pub. Date: Sep. 25, 2008

(54) METHOD AND SYSTEM FOR SHARING FILTERS BETWEEN TRANSMIT AND RECEIVE PATHS IN AN INTEGRATED FM RADIO

(76) Inventor: Bojko Marholev, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/938,007

(22) Filed: Nov. 9, 2007

Related U.S. Application Data
(60) Provisional application No. 60/895,665, filed on Mar. 19, 2007.
(60) Provisional application No. 60/895,667, filed on Mar. 19, 2007.

(51) Int. Cl. H04B 1/40; H04J 3/00

(52) U.S. Cl. 370/280; 455/84

(57) ABSTRACT

Aspects of a method and system for sharing filters between transmit and receive paths in an integrated FM radio are provided. In this regard, a FM radio receive processing path and a FM radio transmit processing path may each be configured to share a filter. Accordingly, one or more switching elements may enable coupling/decoupling the filter to/from the FM radio transmit and FM radio receive processing paths. Furthermore, the switching elements may be programmatically controlled by a processor and/or memory. Additionally, by coupling the filter to the transmit receive paths during alternating time intervals, aspects of the invention may enable simulating simultaneous transmission and reception of FM radio signals utilizing while sharing one or more filters. In various embodiments of the invention, separate filters may be utilized for an in-phase processing path and a quadrature phase processing path.

### CROSS-REFERENCE TO RELATED APPLICATIONS/INCORPORATION BY REFERENCE

This patent application makes reference to, claims priority to and claims benefit from U.S. Provisional Patent Application Ser. No. 60/895,665 filed on Mar. 19, 2007.

This patent application makes reference to, claims priority to and claims benefit from U.S. Provisional Patent Application Ser. No. 60/895,667 filed on Mar. 19, 2007.

Each of the above stated applications is hereby incorporated herein by reference in its entirety.

### FIELD OF THE INVENTION

Certain embodiments of the invention relate to signal processing. More specifically, certain embodiments of the invention relate to a method and system for sharing filters between transmit and receive paths in an integrated FM radio.

### BACKGROUND OF THE INVENTION

With the increasing popularity of various wireless standards and technologies, there is a growing demand to provide a simple and complete solution for wireless communications applications. In this regard, electronics manufacturers are increasingly attempting to incorporating multiple wireless technologies into portable electronic devices. For example, wireless technologies that are seeing widespread deployment include FM radio, Bluetooth (BT), GPS, Wi-Fi, and RFID.

Although desirable to users, incorporating multiple wireless communication technologies into devices such as wireless handsets may pose problems in terms of cost and complexity. In this regard, combining a plurality of wireless technologies into a portable electronic device may require separate processing hardware and/or separate processing software. Moreover, coordinating the reception and/or transmission of data to and/or from the portable electronic device may require significant processing overhead that may impose certain operation restrictions and/or design challenges. For example, Bluetooth and Wireless LAN may pose certain coexistence problems caused by the close proximity of the Bluetooth and WLAN transceivers. Furthermore, simultaneous use of a plurality of radios in a handheld may result in significant increases in power consumption.

Another complication associated with incorporating multiple wireless technologies in a single device is that each radio often requires a number of analog components for signal generation, filtering, and other purposes. Consequently, space may quickly become limited as analog blocks, such as filters, may require a significant amount of area.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for sharing filters between transmit and receive paths in an integrated FM radio, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of an exemplary portable electronic device comprising integrated support for multiple wireless technologies, in accordance with an embodiment of the invention.

FIG. 2 is a block diagram of an exemplary single chip with multiple integrated wireless technologies, in accordance with an embodiment of the invention.

FIG. 3 is a block diagram of an exemplary FM radio, in accordance with an embodiment of the invention.

FIG. 4 is a block diagram of an exemplary FM radio sharing filters between a transmit path and a receive path, in accordance with an embodiment of the invention.

FIG. 5 is a flow chart illustrating exemplary steps in receiving FM radio signals utilizing a shared filter, in accordance with an embodiment of the invention.

FIG. 6 is a flow chart illustrating exemplary steps in transmitting FM radio signals utilizing a shared filter, in accordance with an embodiment of the invention.

### DETAILED DESCRIPTION OF THE INVENTION

Certain embodiments of the invention may be found in a method and system for sharing filters between transmit and receive paths in an integrated FM radio.

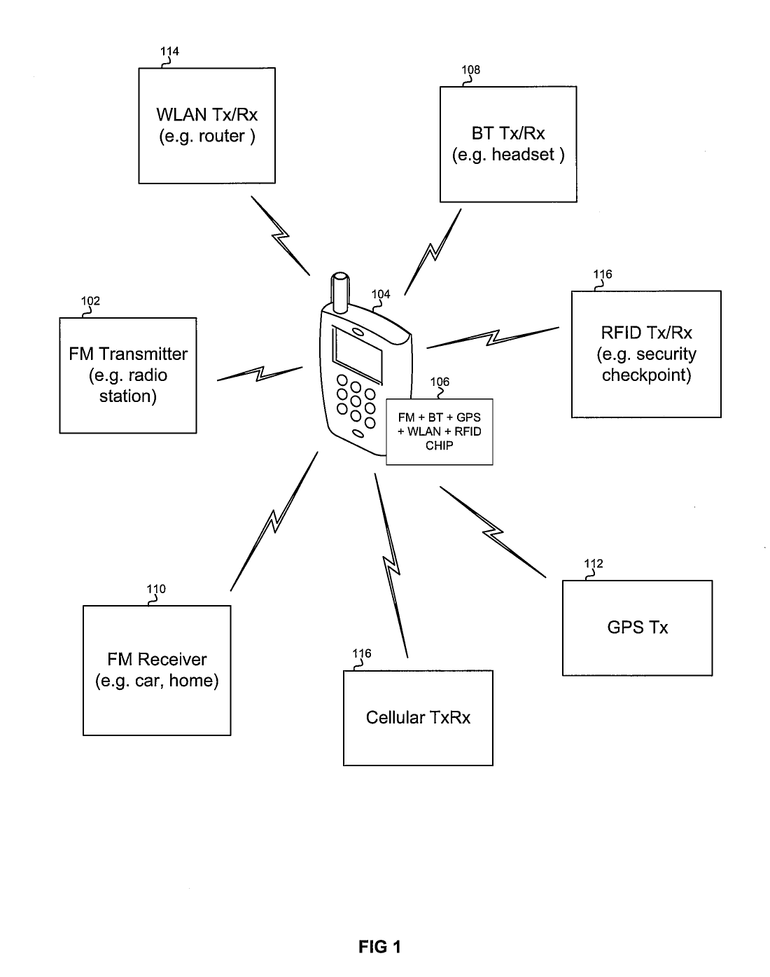

FIG. 1 is a diagram of an exemplary portable electronic device comprising integrated support for multiple wireless technologies, in accordance with an embodiment of the invention. Referring to FIG. 1 there is shown a smart phone 104, a FM radio transmitter 102, a FM radio receiver 110, WLAN transceiver 114, BT transceiver 108, an RFID Transceiver 116, and a GPS transmitter 112.

The FM radio transmitter 102 may, for example, transmit FM radio signals in the “FM broadcast band,” or approximately 60 MHz to 140 MHz. In this regard, the FM radio transmitter 102 may be implemented as part of a radio station. The FM radio receiver 110 may, for example, receive signals in the “FM broadcast band” of approximately 60 MHz to 140 MHz. In this regard, the FM radio receiver 110 may be implemented as part of a home or car stereo system.

The WLAN transceiver 114 may, for example, transmit and receive signals adhering to a wireless standard such as the IEEE 802.11 family of standards. In this regard, the WLAN transceiver may be implemented as part of a wireless router and may operate at a frequency around 2.4 GHz or 5 GHz. Although a single WLAN transceiver is shown, the invention is not limited in this regard. Accordingly, separate WLAN transmitter and WLAN receiver functions may be utilized without departing from the spirit and scope of the invention.

The Bluetooth transceiver 108 may, for example, adhere to one or more Bluetooth standards transmitting and receiving RF signals at or near 2.4 GHz. In this regard, the Bluetooth transceiver 108 may be implemented as part of a wireless headset utilized to transfer audio and/or data information to/from the smart phone 104. Although a single Bluetooth transceiver is shown, the invention is not limited in this regard. Accordingly, separate Bluetooth transmitter and Bluetooth receiver functions may be utilized without departing from the spirit and scope of the invention.

The RFID transceiver 116 may, for example, transmit and/or receive RF signals at or near 900 MHz. In this regard, the RFID transceiver 116 may be implemented as part of a security checkpoint which may provide restricted access to one or more resources requiring a person to present a valid ID in the form of an RFID device or badge.

The GPS transmitter may, for example, transmit RF signals at 1227.6 MHz and 1575.42 MHz. The GPS transmitter may be implemented as part of a satellite. The cellular transceiver 116 may, for example, transmit and receiver RF signals at any of a plurality of frequencies used by various mobile telephony companies and standards. For example, mobile telephone standards in the US may utilize frequencies in the range of 900 MHz to 1.9 GHz. In this regard, the cellular transceiver 116 may be implemented as part of a base station.

The smart phone 104 may comprise a multi-function wireless chip 106 that may comprise suitable logic, circuitry, and/or code that may enable the smart phone to communicate with one or more of the FM radio transmitter 102, the FM radio receiver 110, the WLAN transceiver 114, the BT transceiver 108, the RFID Transceiver 116, the GPS transmitter 112, and the cellular transceiver 116. Accordingly, the chip 106 may be enabled to transmit and/or receive RF signals in a multitude of frequency bands utilizing a multitude of modulation and/or encoding techniques. Accordingly, the chip 106 may utilize advanced and/or specialized signal processing techniques in order to minimize interference between the various wireless technologies. Furthermore, the chip 106 may utilize advanced and/or specialized techniques for minimizing the area of the circuitry required to implement each of the wireless technologies. For example, the chip 106 may be enabled to share filters between FM radio transmit and FM radio receive functions. In this regard, analog filters, particularly at FM broadcast frequencies, may be quite large and implementing fewer of them on chip may significantly reduce circuit area.

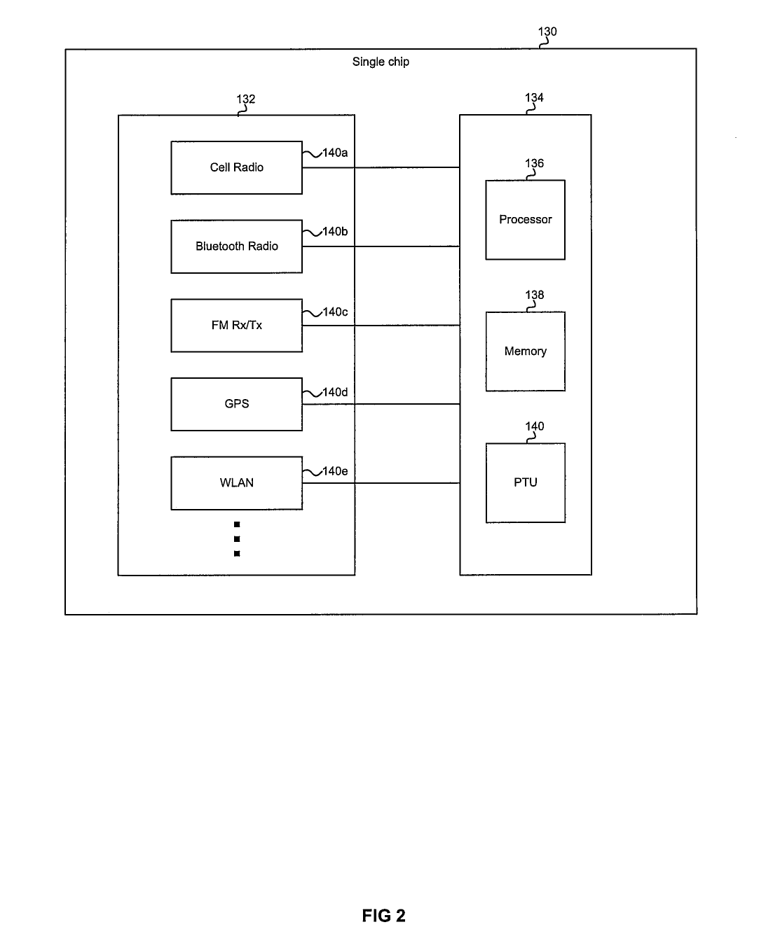

FIG. 2 is a block diagram of an exemplary single chip with multiple integrated wireless technologies, in accordance with an embodiment of the invention. Referring to FIG. 2, there is shown a single chip 130 that may comprise a radio portion 132 and a processing portion 134. The radio portion 132 may comprise a plurality of integrated radios. For example, the radio portion 132 may comprise a cell radio 140a that supports cellular communications, a Bluetooth radio 140b that supports Bluetooth communications, an FM radio receive and transmit (Rx/Tx) radio 140c that supports FM radio communications, a global positioning system (GPS) 140d that supports GPS communications, and/or a wireless local area network (WLAN) 140e that supports communications based on the IEEE 802.11 standards.

The processing portion 134 may comprise at least one processor 136, a memory 138, and a peripheral transport unit (PTU) 140. The processor 136 may comprise suitable logic, circuitry, and/or code that may enable processing of data received from the radio portion 132. In this regard, each of the integrated radios may communicate with the processing portion 134. In some instances, the integrated radios may communicate with the processing portion 134 via a common bus, for example. In various embodiments of the invention, the processor 136 may, for example, enable programmably (programmatically??) controlling one or more switching elements to enable the sharing of circuitry between FM radio transmit and FM radio receive functions. The memory 138 may comprise suitable logic, circuitry, and/or code that may enable storage of data that may be utilized by the processor 136. In this regard, the memory 138 may store at least a portion of the data received by at least one of the integrated radios in the radio portion 132. Moreover, the memory 138 may store at least a portion of the data that may be transmitted by at least one of the integrated radios in the radio portion 132. The PTU 140 may comprise suitable logic, circuitry, and/or code that may enable interfacing data in the single chip 130 with other devices that may be communicatively coupled to the single chip 130. In this regard, the PTU 140 may support analog and/or digital interfaces.

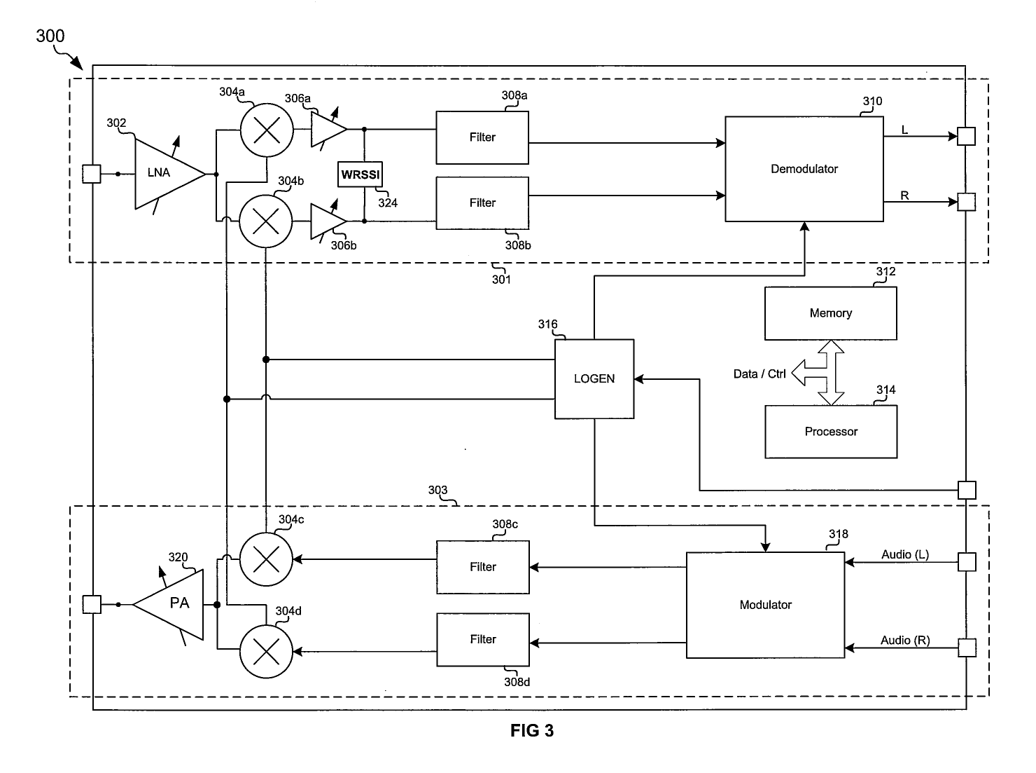

FIG. 3 is a block diagram of an exemplary FM radio, in accordance with an embodiment of the invention. Referring to FIG. 3, the radio may comprise a receive path 301, a transmit path 303, a local oscillator generator 316, a memory 312, and a processor 314.

The FM radio receive path 301 may comprise suitable logic, circuitry, and/or code that may enable the FM radio 300 to receive FM radio signals, for example, in the “FM broadcast band,” or approximately 60 MHz to 140 MHz. In an exemplary embodiment of the invention, the receive path 301 may comprise a low noise amplifier (LNA) 302, a plurality of mixers 304a and 304b, a plurality intermediate frequency (IF) amplifiers 306a and 306b, a wideband received signal strength indicator (WRSSI) 324, a plurality of filters 308a and 308b, and a demodulator 310.

The LNA 302 may comprise suitable logic, circuitry, and/or code that may enable buffering and/or amplifying received RF signals. In this regard, the gain of the LNA 302 may be adjustable to enable reception of signals of varying strength. Accordingly, the LNA 302 may receive one or more control signals from the processor 314.

The mixers 304a and 304b may each comprise suitable logic, circuitry, and/or code that may enable generation of inter-modulation products resulting from the mixing of a received RF signal and a local oscillator signal. The mixer 304a may, for example, be enabled to utilize an in-phase LO signal to generate in-phase inter-modulation products. The mixer 304b may, for example, be enabled to utilize a quadrature phase LO signal to generate quadrature phase inter-modulation products. The frequency of the LO signals may be determined based on the desired received radio frequency. In this regard, the mixers 304a and 304b may enable down-converting received RF signals of varying frequency to an a fixed intermediate frequency (IF). The intermediate frequency may, for example, be chosen to be a frequency that is conducive to signal processing and/or does not result in interference with other circuits integrated into a chip such as the chip 130 of FIG. 2.

The IF amplifiers 306a and 306b may comprise suitable logic, circuitry, and/or code that may enable amplification and/or buffering of signals at or near a desired intermediate frequency. In this regard, the gain of each of the IF amplifiers 306a and 306b may be adjustable and may enable receiving signals of varying strength. Accordingly, the IF amplifiers 306a and 306b may each receive one or more control signals from the processor 314.

The wideband received signal strength indicator (WRSSI) 324 may comprise suitable logic, circuitry, and/or code that may enable determining the strength of a received RF signal and making this information available to the system 300 in the form of an analog and/or digital signal. Accordingly, the WRSSI 324 may, for example, enable the processor 314 to adjust various control signals in response to received signals strength.

The filters 308a and 308b may comprise suitable, logic, and/or code that may enable passing frequencies at or neat the IF and attenuating other frequencies. The bandwidth of the filters may, for example, be suitable for passing a composite FM multiplex comprising stereo audio and RDS data. In this regard, the bandwidth, attenuation, and/or center frequency of each of the filters 308a and 308b may be adjustable based on one or more control signals. Accordingly, the filters 308a and 308b may each receive one or more control signals from the processor 314.

The demodulator 310 may comprise suitable logic, circuitry, and/or code that may enable detection of information comprising a received frequency modulated signal. In this regard, the demodulator 310 may extract information impressed onto an RF carrier and may output this information as analog audio and/or RBDS data, for example. In this regard, the output may comprise left and right audio channels. The demodulator 310 may be enabled to communicate detected information to the memory 312. The demodulator 310 may receive one or more control signals from the processor 318.

The FM radio transmit path 303 may comprise suitable logic, circuitry, and/or code that may enable the FM radio 300 to transmit FM radio signals, for example, in the “FM broadcast band”, or approximately 60 MHZ to 140 MHZ. In an exemplary embodiment of the invention, the transmit path 303 may comprise a modulator 318, a plurality of filters 308c and 308d, a plurality of mixers 304c and 304d, and a power amplifier (PA) 320.

The modulator 318 may comprise suitable logic, circuitry, and/or code that may, for example, enable frequency modulation of an IF carrier with analog audio and/or RBDS data that is to be transmitted by the radio 300. In this regard, data to be transmitted may, for example, be passed to the modulator 318 from the memory 312 or may be received from an external audio source. Accordingly, the modulator may enable processing a right audio channel, a left audio channel, and RDS information into a composite MPX signal and may output two corresponding signals. The modulator 318 may receive information and or control data from the processor 314 and/or the memory 312.

The filters 306c and 306d may comprise suitable, logic, and/or code that may enable passing frequencies at or near the IF and attenuating other frequencies. In this regard, the bandwidth, attenuation, and/or center frequency of each of the filters 308c and 308d may be adjustable based on one or more control signals. Accordingly, the filters 308c and 308d may each receive one or more control signals from the processor 314.

The mixers 304c and 304d may each comprise suitable logic, circuitry, and/or code that may enable generation of inter-modulation products resulting from the mixing of a IF signal and a local oscillator signal. The mixer 304c may, for example, be enabled to utilize an in-phase LO signal to generate in-phase inter-modulation products. The mixer 304b may, for example, be enabled to utilize a quadrature phase LO signal to generate quadrature phase inter-modulation products. The frequency of the LO signals may be determined based on the desired transmitted radio frequency. In this regard, the mixers 304c and 304d may enable up-converting a quadrature IF signal to an RF signal, for example, in the “FM broadcast band”, or approximately 60 MHz to 140 MHz. The IF may, for example, be chosen to be a frequency conducive to signal processing and/or does not result in interference with other circuits comprising a chip such as the chip 130 of FIG. 2.

The PA 320 may comprise suitable logic, circuitry, and/or code that may enable buffering and/or amplification of a FM RF signal and outputting the signal to an antenna for transmission. In this regard, the gain of the PA 320 may be adjustable and may enable transmitting signals of varying strength. Accordingly, the PA 320 may receive one or more control signals from the processor 314.

The local oscillator generator (LOGEN) 316 may comprise suitable logic, circuitry, and/or code that may enable generation of one or more signals of varying frequency. In this regard, the LOGEN 316 may be enabled to generate local oscillator frequencies which may be utilized in up-converting FM radio signals for transmission and down-converting received FM radio signals. The LOGEN 316 may be enabled to generate pairs of signals in phase quadrature. Additionally, the LOGEN 316 may generate one or more signals utilized by the modulator 318 and/or the demodulator 310. In this regard, the LOGEN 316 may, for example, generate one or more sampling frequencies utilized by analog-to-digital converters and/or digital-to-analog converters comprising the modulator 318 and/or the demodulator 310. The LOGEN 316 may generate signals of variable frequency based on a fixed-frequency reference signal. In this regard, the LOGEN 316 may be configurable and may receive one or more control signals from the processor 314.

The memory 312 may comprise suitable logic, circuitry, and/or code that may enable storing data that may be utilized for transmission and/or reception of FM radio signals. In this regard, the memory 312 may, for example, enable storing received audio, RDS, and/or RBDS data. Similarly, the memory 312 may enable storing digital audio, RDS, and/or RBDS data that is to be transmitted. Additionally, the memory 312 may enable storing data utilized in configuring the various blocks of the FM radio 300. Accordingly, the memory 312 may receive one or more control signals from the processor 312.

The processor 314 may comprise suitable logic, circuitry, and/or code that may enable configuring and/or controlling the FM radio 300. In this regard, the processor 314 may be enabled to execute one or more instructions that may enable providing one or more control signals to the various blocks comprising the FM radio 300. Furthermore, the processor 312 may be enabled to control the exchange of data between the memory 312 and the various other blocks of the FM radio 300.

In an exemplary receive operation, the FM radio 300 may be configured to transmit FM radio signals or to receive FM radio signals. To receive FM radio signals, the processor 314 may generate one or more control signals that power down the blocks comprising the FM radio transmit path 303 and power up the blocks comprising the FM radio receive path 301. Additionally, the LOGEN 316 may be configured to generate a pair of LO signals at an appropriate frequency for down converting the desired frequency band to the IF. The LNA 302 may amplify a received signal. The amplified signal may then be communicated to the two mixers 304a and 304b which may utilize the pair of LO signals to generate in-phase and quadrature phase IF signals. The IF signals may be amplified by the IF amplifiers 306a and 306b. The filters 308a and 308b may filter out the undesired mixer products and pass the desired IF frequency. The demodulator 310 may extract the information contained in the frequency modulated IF signal and may output the extracted information. Additionally, the extracted data may be stored in the memory 312.

In an exemplary transmit operation, the processor 314 may provide one or more control signals that power down the blocks comprising the FM radio receive path 301 and power up the blocks comprising the receive path 303. Additionally, the LOGEN 316 may be configured to generate a pair of LO signals at an appropriate frequency for up-converting the IF to a desired RF transmit frequency. The modulator 318 may receive an analog stereo (left and right) signals and RDS information and may generate a composite MPX signal to frequency modulate an IF carrier. Accordingly, the modulator may output an in-phase (I) and a quadrature-phase (Q) IF signal. Each IF signal may pass through one of the filters 308c and 308d where signals outside the FM channel, for example, may be attenuated. The mixers 304c and 304d may up-convert the filtered quadrature IF signals to the desired RF transmit frequency. The two channels comprising the up-converted signal may be combined into a SSB FM modulated RF signal that may be transmitted via an antenna.

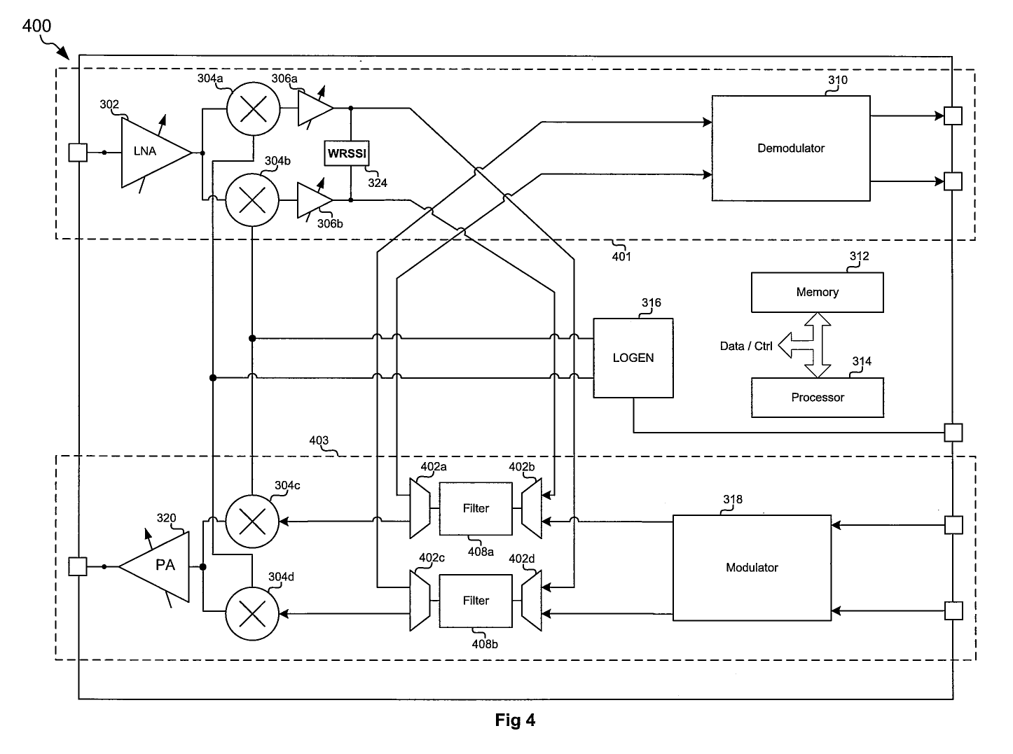

FIG. 4 is a block diagram of an exemplary FM radio sharing filters between a transmit path and a receive path, in accordance with an embodiment of the invention. Referring to FIGS. 3 and 4, the radios may differ in that the radio 400 shares filters between the receive path 401 and the transmit path 403. Accordingly, the radio 400 may comprise a number of switching elements 402 that enable sharing the filters 408a and 408b.

The filters 408a and 408b may comprise suitable, logic, and/or code that may enable passing frequencies at or near the IF and attenuating other frequencies. The filters 408 may be similar to or the same as the filters 308a, 308b, 308c, and/or 308d. The bandwidth of the filters may, for example, be suitable for passing a composite FM multiplex comprising stereo audio and RDS data. In this regard, the bandwidth, attenuation, and/or center frequency of each of the filters 408a and 408b may be adjustable based on one or more control signals. Accordingly, the filters 408a and 408b may each receive one or more control signals from the processor 314.

The switching elements 402a, 402b, 402c, and 402d may comprise suitable circuitry, logic, and/or code that may enable communicatively coupling/decoupling the filters 408a and 408b to/from the receive path 401 and the transmit path 403. In this regard, the radio 400 may switch between transmit and receive operation as needed. In an exemplary embodiment of the invention, the switching elements 402a, 402b, 402c, and 402d may switch between the receive path 401 and the transmit path 403 in alternate time intervals. In this manner, transmit and receive functions may be time division duplexed. Accordingly, the processor 314 may be enabled to execute one or more instructions and/or generate one or more control signals to control the operation of the switches 402a, 402b, 402c, and 402d. By sharing the filters 408a and 408b between the two paths, the size and peak power consumption of the radio 400 may be significantly reduced as compared to the radio 300.

In an exemplary receive operation, the processor 314 may provide one or more control signals that power down the blocks comprising the FM radio transmit path 303 and power up the blocks comprising the FM radio receive path 301. Additionally, the LOGEN may be configured to generate a pair of LO signals at an appropriate frequency for down converting the desired frequency band to IF. Moreover, one or more control signals may be provided to the switching elements 402a, 402b, 402c, and 402d, such that the filters are decoupled from the transmit path 403 and coupled into the receive path 401. The LNA 302 may amplify the received signal. The amplified signal may then be provided to the two mixers 304a and 304b which may utilize the pair of LO signals to generate in-phase and quadrature phase IF signals. The IF signals may be amplified by the IF amplifiers 306a and 306b. The filters 408a and 408b may filter out the undesired mixer products and pass the desired IF frequency. The demodulator 310 may extract the information contained in the frequency modulated IF signal and may output the extracted information. Additionally, the extracted data may be stored in the memory 312.

In an exemplary transmit operation, the processor 314 may provide one or more control signals that power down the blocks comprising the FM radio receive path 301 and power up the blocks comprising the receive path 303. Additionally, the LOGEN may be configured to generate a pair of LO signals at an appropriate frequency for up converting the IF to the desired frequency band. Moreover, one or more control signals may be provided to the switching elements 402a, 402b, 402c, and 402d, such that the filters are decoupled from the transmit path 403 and coupled into the receive path 401. The modulator 318 may, for example, process left and right audio signals and RDS information and may generate a composite MPX signal to frequency modulate an IF carrier. Accordingly, the modulator 318 may output an in-phase (I) and quadrature-phase (Q) IF signal. Each IF signal may then proceed to one of the filters 308c and 308d where frequencies outside the FM channel spectrum, for example, may be attenuated. The mixers 304c and 304d may then up-convert the quadrature IF signals to the desired RF transit frequency. The two channels comprising the up-converted signal may then be combined into SSB (single side band) modulated RF carrier that may be transmitted via an antenna.

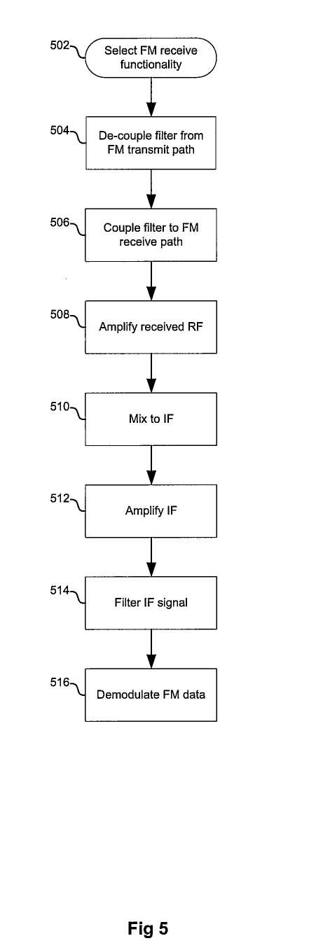

FIG. 5 is a flow chart illustrating exemplary steps in receiving FM radio signals utilizing a shared filter, in accordance with an embodiment of the invention. Referring to FIG. 5, FM reception may begin with step 502 when receive functionality is selected in an integrated FM radio. In this regard, receive functionality may, for example, be selected by a user input. Once FM radio receive functionality is selected, in step 504 a filter shared between FM radio transmit and FM radio receive paths such as the paths 401 and 403 shown in FIG. 4, may be decoupled from the FM radio transmit path. In this regard, the filter may be similar to or the same as the filter 408a and/or 408b and may be decoupled by configuring switching elements similar to or the same as the switching elements 402. In step 506 the shared filter may be coupled to the FM radio receive path by, for example, configuring switching elements similar to or the same as the switching elements 402. In step 508, a received FM signal may be amplified by, for example, a LNA such as the LNA 302 of FIG. 4. In step 510, the amplified RF signal may be mixed down to an IF frequency. In this regard, the mixing may be performed by one or more mixers similar to or the same as the mixers 304 in FIG. 4. In step 512 the IF signals may be amplified, for example, by amplifiers similar to or the same as the IF amplifiers 306. In step 514 the amplified IF signal may be filtered by the shared filter. In step 516 the FM signal may be demodulated. For example, audio, RDS, and/or RBDS data may be extracted from the received FM signal.

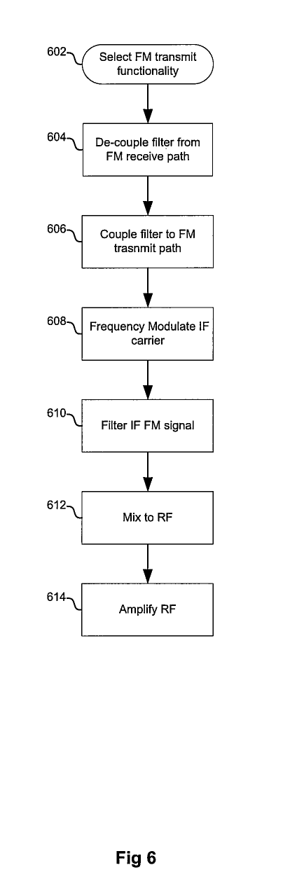

FIG. 6 is a flow chart illustrating exemplary steps in transmitting FM radio signals utilizing a shared filter, in accordance with an embodiment of the invention. Referring to FIG. 6, FM transmission may begin with step 602 when receive functionality is selected in an integrated FM radio. In this regard, transmit functionality may, for example, be selected by a user input. In step 604 a filter shared between FM radio transmit and FM radio receive paths, such as the paths 401 and 403 of FIG. 4, may be decoupled from the FM radio receive path. In step 606 the shared filter may be coupled to the FM radio transmit path. In this regard, the filter may be similar to or the same as the filter 408a and/or 408b described in FIG. 4. In step 608 an IF carrier may be frequency modulated with audio information. In step 610 the IF FM signal may be filtered by the shared filter. In step 612, the IF signal may be mixed to an FM broadcast frequency. In this regard, the mixing may be performed by one or more mixers similar to or the same as the mixers 304 in FIG. 4. In step 614, a power amplifier similar to or the same as the PA 320 shown in FIG. 4 may amplify the FM signal for transmission to a remote FM radio receiver.

Aspects of the invention may enable sharing one or more filters, such as the filters 408 in FIG. 4, between an FM radio transmit function and a FM radio receive function in an integrated FM radio. In this regard, a FM radio receive processing path, such as the receive chain 401 in FIG. 4, and a FM radio transmit processing path, such as the transmit chain 403 of FIG. 4, may each be configured to share a filter. Accordingly, one or more switching elements may enable coupling/de-coupling the filter to/from the transmit and receive paths. Furthermore, the switches may be programmatically controlled by a processor and/or memory such as the processor 314 and the memory 312. Additionally, by coupling the filter to the transmit and receive paths during alternating time intervals, aspects of the invention may enable simulating simultaneous transmission and reception of FM signal while sharing one or more filters. In various embodiments of the invention, separate filters, such as 408a and 408b, may be utilized for an in-phase processing path and a quadrature phase processing path.

Another embodiment of the invention may provide a machine-readable storage, having stored thereon, a computer program having at least one code section executable by a machine, thereby causing the machine to perform the steps as described herein for sharing filters between transmit and receive paths in an integrated FM radio.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising: in an integrated circuit comprising FM radio transmit and FM radio receive functions, sharing one or more filters for processing received FM radio signals and for processing FM radio signals for transmission.

2. The method according to claim 1, comprising configuring an FM radio receive processing path within said integrated circuit for said sharing of said one or more filters for said processing of said received FM radio signals.

3. The method according to claim 2, comprising switching during said configuring, said one or more filters into said FM radio receive processing path for said processing of said received FM radio signals.

4. The method according to claim 3, comprising programmably controlling said switching of said one or more filters during said configuring.

5. The method according to claim 1, comprising configuring an FM radio transmit processing path within said integrated circuit for said sharing of said one or more filters for said processing of said FM radio signals to be transmitted.

6. The method according to claim 5, comprising switching during said configuring, said one or more filters into said FM radio transmit processing path for said processing of said FM radio signals to be transmitted.

7. The method according to claim 6, comprising programmably controlling said switching of said one or more filters during said configuring.

8. The method according to claim 1, comprising enabling time division duplexing of receiving of said received FM radio signals, and said transmitting of said FM radio signals.

9. The method according to claim 8, comprising:
enabling said one or more filters for said receiving of said received FM radio signals in a first time interval; and
enabling said one or more filters for said transmitting of said FM radio signals in a time interval successive to said first time interval.

10. The method according to claim 1, comprising:
sharing said one or more filters in an in-phase path utilized for processing received FM radio signals and with a corresponding in-phase path utilized for processing FM radio signals for transmission; and
sharing said one or more filters in a quadrature path utilized for processing received FM radio signals and with a corresponding quadrature path utilized for processing FM radio signals for transmission.

11. A machine-readable storage having stored thereon, a computer program having at least one code section for processing signals in a communication system, the at least one code section being executable by a machine for causing the machine to perform steps comprising: in an integrated circuit comprising FM radio transmit and FM radio receive functions, sharing one or more filters for processing received FM radio signals and for processing FM radio signals for transmission.

12. The machine-readable storage according to claim 11, wherein said at least one code section comprises code for configuring an FM radio receive processing path within said integrated circuit for said sharing of said one or more filters for said processing of said received FM radio signals.

13. The machine-readable storage according to claim 12, wherein said at least one code section comprises code for switching during said configuring, said one or more filters into said FM radio receive processing path for said processing of said received FM radio signals.

14. The machine-readable storage according to claim 13, wherein said at least one code section comprises code for programmably controlling said switching of said one or more filters during said configuring.

15. The machine-readable storage according to claim 11, wherein said at least one code section comprises code for configuring an FM radio transmit processing path within said integrated circuit for said sharing of said one or more filters for said processing of said FM radio signals to be transmitted.

16. The machine-readable storage according to claim 15, wherein said at least one code section comprises code for switching during said configuring, said one or more filters into said FM radio transmit processing path for said processing of said FM radio signals to be transmitted.

17. The machine-readable storage according to claim 16, wherein said at least one code section comprises code for programmably controlling said switching of said one or more filters during said configuring.

18. The machine-readable storage according to claim 11, wherein said at least one code section comprises code for enabling time division duplexing of receiving of said received FM radio signals, and said transmitting of said FM radio signals.

19. The machine-readable storage according to claim 18, wherein said at least one code section comprises:
code for enabling said one or more filters for said receiving of said received FM radio signals in a first time interval; and
code for enabling said one or more filters for said transmitting of said FM radio signals in a time interval successive to said first time interval.

20. The machine-readable storage according to claim 11, wherein said at least one code section comprises:
code for sharing said one or more filters in an in-phase path utilized for processing received FM radio signals and with a corresponding in-phase path utilized for processing FM radio signals for transmission; and
code for sharing said one or more filters in a quadrature path utilized for processing received FM radio signals and with a corresponding quadrature path utilized for processing FM radio signals for transmission

21. A system for processing signals in a communication system, the system comprising: one or more circuits in an integrated circuit that enables FM radio transmit and FM radio receive functions, wherein said one or more circuits enables sharing one or more filters for processing received FM radio signals and for processing FM radio signals for transmission.

22. The system according to claim 21, wherein said one or more circuits enable configuration of an FM radio receive processing path within said integrated circuit for said sharing of said one or more filters for said processing of said received FM radio signals.

23. The system according to claim 22, wherein said one or more circuits enable switching, during said configuring, of said one or more filters into said FM radio receive processing path for said processing of said received FM radio signals.

24. The system according to claim 23, wherein said one or more circuits enable programmable control of said switching of said one or more filters during said configuring.

25. The system according to claim 21, wherein said one or more circuits enable configuration an FM radio transmit processing path within said integrated circuit for said sharing of said one or more filters for said processing of said FM radio signals to be transmitted.

26. The system according to claim 25, wherein said one or more circuits enable switching, during said configuring, of said one or more filters into said FM radio transmit processing path for said processing of said FM radio signals to be transmitted.

27. The system according to claim 26, wherein said one or more circuits enable programmable control said switching of said one or more filters during said configuring.

28. The system according to claim 21, wherein said one or more circuits enable time division duplexing of receiving of said received FM radio signals, and said transmitting of said FM radio signals.

29. The system according to claim 28, wherein:
wherein said one or more circuits enable said one or more filters for said receiving of said received FM radio signals in a first time interval; and
wherein said one or more circuits enable said one or more filters for said transmitting of said FM radio signals in a time interval successive to said first time interval.

30. The system according to claim 21, wherein:
wherein said one or more circuits enable said one or more filters in an in-phase path utilized for processing received FM radio signals and with a corresponding in-phase path utilized for processing FM radio signals for transmission; and
wherein said one or more circuits enable said one or more filters in a quadrature path utilized for processing received FM radio signals and with a corresponding quadrature path utilized for processing FM radio signals for transmission.
